(19) United States
(12) Patent Application Publication
(10) Pub. No.: US 2026/0142068 A1
(43) Pub. Date: May 21, 2026

(54) INDUCTOR AND METHOD FOR MANUFACTURING INDUCTOR

(71) Applicant: Murata Manufacturing Co., Ltd., Kyoto-fu (JP)

(72) Inventor: Masato NOMIYA, Nagaokakyo-shi (JP)

(73) Assignee: Murata Manufacturing Co., Ltd., Kyoto-fu (JP)

(21) Appl. No.: 19/450,454

(22) Filed: Jan. 15, 2026

Related U.S. Application Data
(63) Continuation of application No. PCT/JP2024/023490, filed on Jun. 28, 2024.

(30) Foreign Application Priority Data
Oct. 5, 2023 (JP) 2023-173665

(51) Int. Cl. H01F 27/28; H01F 27/29; H01F 41/04

(52) U.S. Cl. CPC H01F 27/2804; H01F 27/29; H01F 41/041; H01F 2027/2809

(57) ABSTRACT

An inductor in which an element body forming a magnetic body has higher strength, and to provide a method for manufacturing the inductor. An inductor includes an element body containing powder particles and a resin and incorporating a coil; and outer electrodes formed in or on the element body and electrically connected to the coil. The element body includes a first element body portion incorporating the coil and having a first coefficient of linear expansion, and a second element body portion on a first main surface and/or a second main surface and having a second coefficient of linear expansion that is lower than the first coefficient of linear expansion. The first main surface faces a lower surface of the coil of the first element body portion, and the second main surface is opposed to the first main surface.

### CROSS-REFERENCE TO RELATED APPLICATIONS

This application claims benefit of priority to International Patent Application No. PCT/JP2024/023490, filed Jun. 28, 2024, and to Japanese Patent Application No. 2023-173665, filed Oct. 5, 2023, the entire contents of each are incorporated herein by reference.

### BACKGROUND

### Technical Field

The present disclosure relates to an inductor and a method for manufacturing an inductor.

### Background Art

Japanese Unexamined Patent Application Publication No. 2016-186963 discloses a laminated electronic component in which magnetic layers and conductor patterns are laminated so that the conductor patterns between the magnetic layers are connected, thereby forming coils in a multilayer body.

### SUMMARY

In electronic equipment in which the laminated electronic component described in Japanese Unexamined Patent Application Publication No. 2016-186963 is mounted on a mounting board or the like, when an unintentional impact (for example, an impact caused by a fall or the like of portable electronic equipment) is applied to the electronic equipment, there may be cases in which the mounting board is instantaneously deflected and deformed. There is also a possibility that the laminated electronic component is affected by the deflection deformation of the mounting board.

The present disclosure has been made in view of the above. That is, the present disclosure provides an inductor in which an element body forming a magnetic body has higher strength, and provides a method for manufacturing an inductor.

An inductor of the present disclosure includes an element body containing powder particles and a resin, and incorporating a coil; and an outer electrode formed in or on the element body, and electrically connected to the coil. The element body includes a first element body portion incorporating the coil and having a first coefficient of linear expansion, and a second element body portion provided on a first main surface and/or a second main surface and having a second coefficient of linear expansion that is lower than the first coefficient of linear expansion. The first main surface faces a lower surface of the coil of the first element body portion, and the second main surface is opposed to the first main surface.

A method for manufacturing an inductor of the present disclosure includes an element body forming step of forming an element body containing powder particles and a resin and incorporating a coil. The element body forming step includes a first forming step of forming a precursor of a first element body portion incorporating the coil and having a first coefficient of linear expansion, and a second forming step of forming a precursor of a second element body portion provided on a first main surface and/or a second main surface and having a second coefficient of linear expansion that is lower than the first coefficient of linear expansion. The first main surface faces a lower surface of the coil in the precursor of the first element body portion, and the second main surface is opposed to the first main surface. The element body forming step further includes a first heat treatment step of performing heat treatment on the precursor of the first element body portion and on the precursor of the second element body portion, and a second heat treatment step of causing the precursor of the first element body portion and the precursor of the second element body portion, on which the heat treatment is performed, to be impregnated with the resin, and of performing heat treatment on the precursor of the first element body portion and the precursor of the second element body portion to obtain the element body including the first element body portion and the second element body portion, containing the powder particles and the resin, and incorporating the coil. The first element body portion has the first coefficient of linear expansion, the second element body portion has the second coefficient of linear expansion.

According to the present disclosure, it is possible to provide an inductor in which an element body forming a magnetic body has higher strength, and to provide a method for manufacturing an inductor.

### BRIEF DESCRIPTION OF THE DRAWINGS

FIG. 1 is a perspective view of an inductor of the present disclosure;

FIG. 2 is an exploded perspective view of the inductor of a first embodiment;

FIG. 3 is a sectional view of the inductor of the first embodiment;

FIG. 4 is an enlarged sectional view of a main part of FIG. 3;

FIG. 5 is a diagram illustrating deflection deformation of the inductor of the present disclosure;

FIG. 6 is a sectional view of an inductor of a modification of the first embodiment;

FIG. 7 is a sectional view of an inductor of another modification of the first embodiment;

FIG. 8 is a sectional view of an inductor of another modification of the first embodiment;

FIG. 9 is a sectional view of an inductor of another modification of the first embodiment;

FIG. 10 is an exploded perspective view of an inductor of a second embodiment;

FIG. 11 is a sectional view of the inductor of the second embodiment;

FIG. 12 is an exploded perspective view of an inductor of a third embodiment;

FIG. 13 is a sectional view of the inductor of the third embodiment;

FIG. 14 shows a manufacturing flow of a method for manufacturing the inductor of the present disclosure;

FIG. 15 is a table showing results of a verification test of the inductor of the present disclosure.

### DETAILED DESCRIPTION

Hereinafter, an inductor of the present disclosure will be described. The present disclosure is not limited to the following configurations, and may be suitably changed without departing from the gist of the present disclosure. Combinations of the plurality of individual preferred configurations described below are also encompassed by the present disclosure.

The inductor of the present disclosure is used for a DC-DC converter, for example. The inductor of the present disclosure may also be used in applications other than DC-DC converters.

In this specification, terms indicating relationships between elements (such as “parallel” and “orthogonal”) and terms indicating shapes of elements are used not only in their strict sense, but also to encompass substantially equivalent ranges, for example, ranges including differences of approximately several percent. In this specification, a direction in which magnetic layers and coil conductors, which form an element body, are laminated is taken as “lamination direction”.

In the description of this specification, any reference to direction or orientation is merely for convenience of explanation and is not intended to limit the scope of the present disclosure, unless otherwise explicitly specified. For example, relative terms, such as “outer (or outer side portion, outer portion, or outer periphery)” and “inner (or inner side portion, inner portion, or inner periphery)” as well as derivatives thereof, should be construed as indicating directions described in this specification or shown in the drawings. That is, these relative terms do not require that the description be limited to only a particular direction, orientation, or mode, unless otherwise expressly described. In the same manner, terms such as “provided”, “disposed”, and “connected”, as well as derivatives thereof, refer to relationships between structures that may be provided either directly or indirectly through other elements, such as intervening structures, unless otherwise expressly described.

Drawings shown below are schematic, and their dimensions, aspect ratio scales, and the like may differ from those of the actual product.

### Inductor of First Embodiment

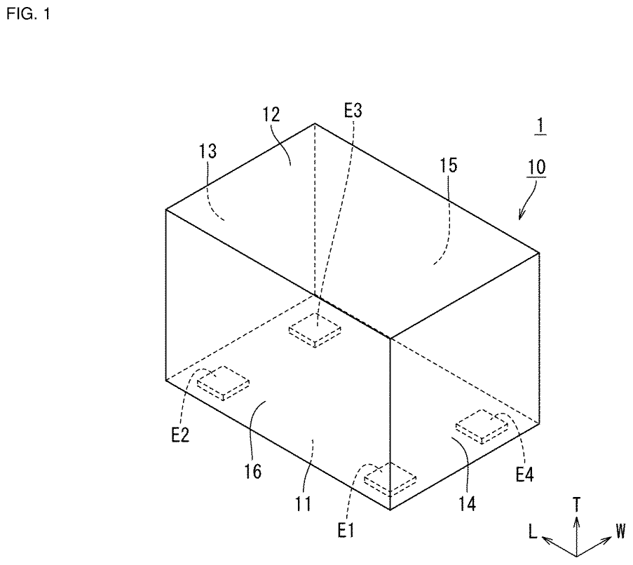

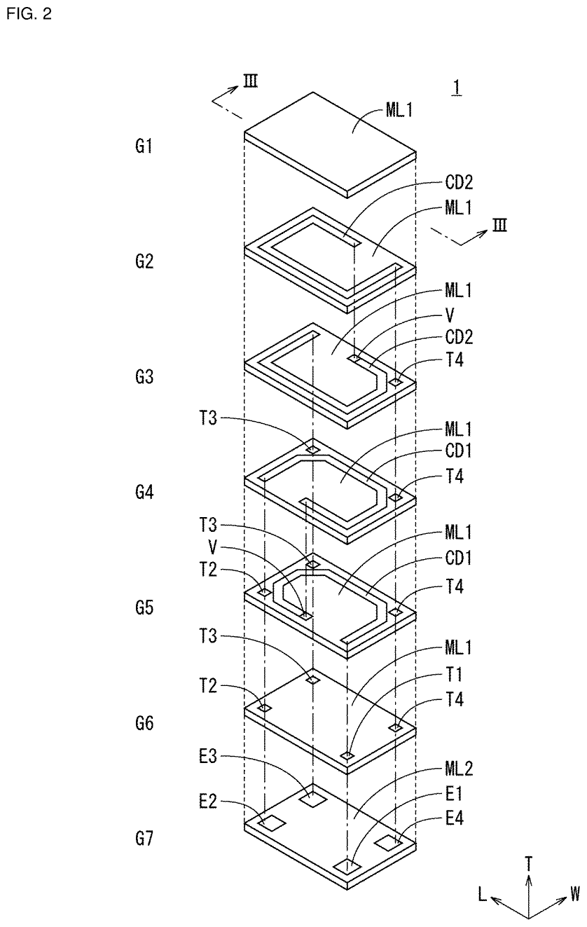

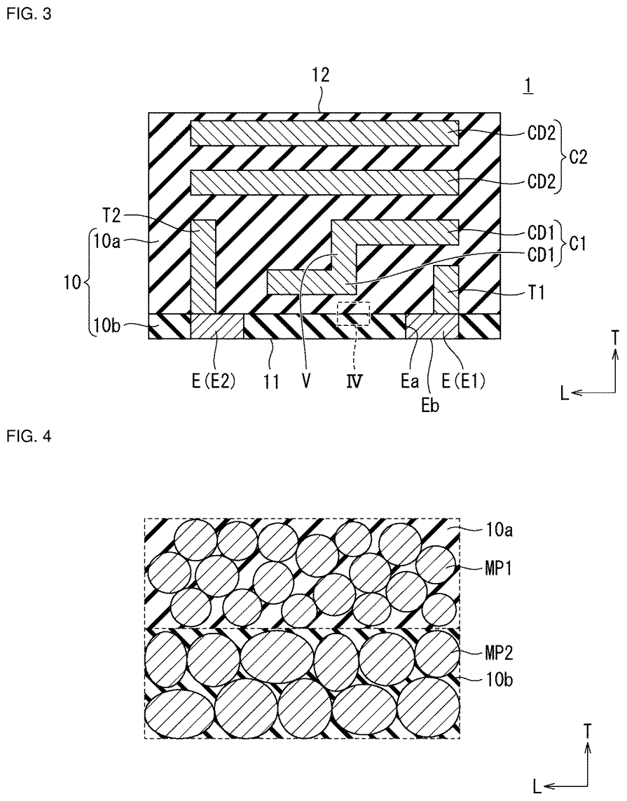

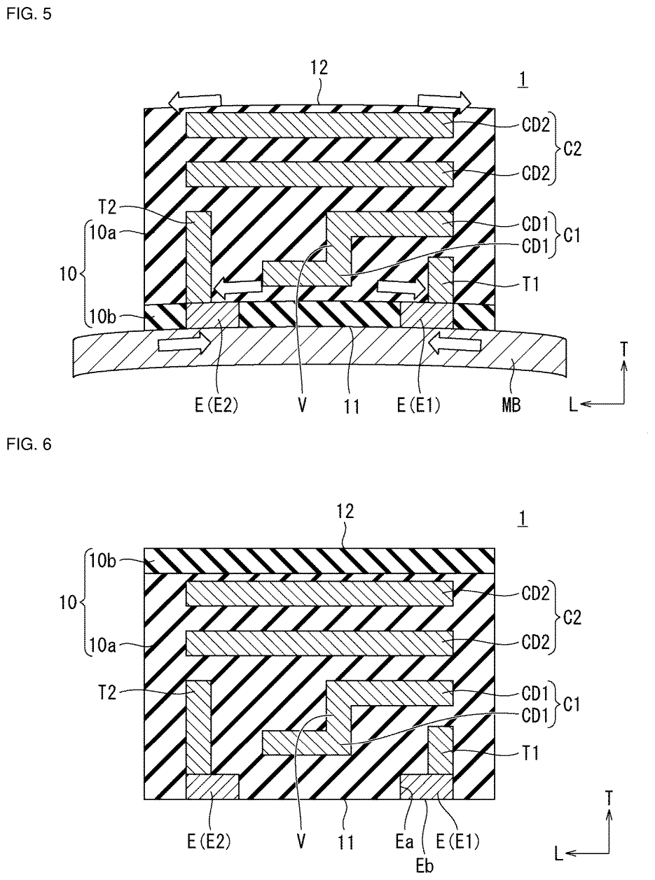

An inductor of a first embodiment will be described with reference to FIGS. 1 to 5. FIG. 1 is a perspective view of the inductor of the present disclosure, FIG. 2 is an exploded perspective view of the inductor of the first embodiment, FIG. 3 is a sectional view of the inductor of the first embodiment, FIG. 4 is an enlarged sectional view of a main part of FIG. 3, and FIG. 5 is a diagram illustrating deflection deformation of the inductor of the present disclosure. The shape, arrangement, and the like of the inductor and respective constitutional elements are not limited to those shown in the drawings as examples.

An inductor 1 of the present disclosure includes an element body 10 and outer electrodes E1 to E4, the element body 10 containing powder particles and a resin and incorporating coils, the outer electrodes E1 to E4 being formed in the element body 10 and being electrically connected to the coils (see FIG. 1).

In the present embodiment, the element body 10 includes a first coil C1 and a second coil C2, which is disposed above the first coil C1 in a height direction T (see FIG. 3). By laminating lamination groups G4 and G5 (see FIG. 2), which will be described later, first coil conductors CD1 are wound into a helical shape through a via conductor V (see FIG. 3), thereby forming the first coil C1. By laminating lamination groups G2 and G3 (see FIG. 2), which will be described later, second coil conductors CD2 are wound into a helical shape through a via conductor (not shown in the drawing), thereby forming the second coil C2.

The coils included in the element body 10 are not limited to the above-mentioned mode, and the element body 10 may include one coil, or may include two or more coils. For example, a plurality of coils may be arranged in the element body 10 in parallel in a direction (the L direction in FIG. 3) intersecting the lamination direction, thereby forming a coil array. The number of outer electrodes may be increased according to the number of coils. For example, in a case in which the first coils C1 shown in FIG. 2 are arranged side by side in the L direction in FIG. 2 and the second coils C2 shown in FIG. 2 are arranged side by side in the L direction in FIG. 2, thus causing the element body 10 to include four coils in total, the number of outer electrodes may be set according to the four coils, that is, eight outer electrodes may be provided. In a case in which either one of the first coil C1 or the second coil C2 forms the coils shown in FIG. 2, the number of outer electrodes may be set according to the one coil, that is, two outer electrodes may be provided.

Hereinafter, respective constitutional elements will be described in detail.

### Element Body

The element body 10 has, for example, a rectangular parallelepiped shape or a substantially rectangular parallelepiped shape having six surfaces. The corner portions and the ridge portions of the element body 10 may be rounded. The corner portion refers to a portion where three surfaces of the element body 10 intersect each other. The ridge portion refers to a portion where two surfaces of the element body 10 intersect each other.

In FIG. 1, the length direction, the width direction, and the height direction of the inductor 1 and the element body 10 are respectively indicated as L direction, W direction, and T direction. The length direction L, the width direction W, and the height direction T are orthogonal to each other. The mounting surface of the inductor 1 is, for example, a surface (LW surface) parallel to the length direction L and the width direction W.

The element body 10 shown in FIG. 1 has a first main surface 11, a second main surface 12, a first end surface 13, a second end surface 14, a first side surface 15, and a second side surface 16, the first main surface 11 and the second main surface 12 being opposed to each other in the height direction T, the first end surface 13 and the second end surface 14 being opposed to each other in the length direction L, which is orthogonal to the height direction T, the first side surface 15 and the second side surface 16 being opposed to each other in the width direction W, which is orthogonal to the length direction L and the height direction T. In the example shown in FIG. 1, the first main surface 11 of the element body 10 corresponds to the mounting surface (bottom surface) of the element body 10. The second main surface 12 may form the mounting surface of the element body 10.

The element body 10 has a laminated structure in which an element body layer and a plurality of element body layers are laminated in a lamination direction (for example, the height direction T), coil conductors being formed in the plurality of element body layers. In the present embodiment, the element body 10 is formed by laminating lamination groups G1 to G7 as shown in FIG. 2. The boundaries between the respective layers of the laminated structure of the element body 10 are eliminated. Each lamination group layer may be formed by laminating a plurality of same patterns.

The element body 10 includes a first element body portion 10a and a second element body portion 10b, the first element body portion 10a incorporating the first coil C1 and the second coil C2 and having a first coefficient of linear expansion, the second element body portion 10b having a second coefficient of linear expansion that is lower than the first coefficient of linear expansion (see FIG. 3). The first element body portion 10a corresponds to the lamination groups G1 to G6 shown in FIG. 2, and the second element body portion 10b corresponds to the lamination group G7 shown in FIG. 2. Hereinafter, the lamination groups G1 to G7 will be described in detail.

### (Lamination Group G1)

The lamination group G1 forming the first element body portion 10a includes a first element body layer ML1, and forms the second main surface 12 of the element body 10.

### (Lamination Group G2)

The lamination group G2 forming the first element body portion 10a includes a first element body layer ML1 and a second coil conductor CD2, the second coil conductor CD2 forming a portion of the second coil C2 provided in the first element body layer ML1.

The second coil conductor CD2 of the lamination group G2 forms one turn of the second coil C2. More specifically, the second coil conductor CD2 is disposed on the first element body layer ML1 along the substantially outer peripheral edge of the first element body layer ML1. One end of the second coil conductor CD2 is connected to a via conductor (not shown in the drawing) so as to be connected to a second coil conductor CD2 that is provided on a first element body layer ML1 of the lamination group G3. The other end of the second coil conductor CD2 is connected to a fourth through-hole conductor (not shown in the drawing) so as to be electrically connected to the fourth outer electrode E4.

### (Lamination Group G3)

The lamination group G3 forming the first element body portion 10a includes the first element body layer ML1, the second coil conductor CD2, and a fourth through-hole conductor T4, the second coil conductor CD2 forming a portion of the second coil C2 provided in the first element body layer ML1, the fourth through-hole conductor T4 being provided in the first element body layer ML1.

The second coil conductor CD2 of the lamination group G3 forms the other turn of the second coil C2. More specifically, the second coil conductor CD2 is disposed on the first element body layer ML1 along the substantially outer peripheral edge of the first element body layer ML1. One end of the second coil conductor CD2 is connected to the second coil conductor CD2 that is provided on the first element body layer ML1 of the lamination group G2, and the other end of the second coil conductor CD2 is connected to a third through-hole conductor (not shown in the drawing) so as to be electrically connected to the third outer electrode E3.

The fourth through-hole conductor T4 of the lamination group G3 connects the fourth through-hole conductors T4 of the lamination groups G2 and G4, which are disposed adjacent to the lamination group G3 in the lamination direction, and is electrically conducted to the fourth outer electrode E4. Accordingly, the fourth through-hole conductor T4 may be disposed at a corner portion of the first element body layer ML1, which is located above the fourth outer electrode E4.

### (Lamination Group G4)

The lamination group G4 forming the first element body portion 10a includes a first element body layer ML1, a first coil conductor CD1, a third through-hole conductor T3, and the fourth through-hole conductor T4, the first coil conductor CD1 forming a portion of the first coil C1 provided in the first element body layer ML1, the third through-hole conductor T3 and the fourth through-hole conductor T4 being provided in the first element body layer ML1.

The first coil conductor CD1 of the lamination group G4 forms one turn of the first coil C1. More specifically, the first coil conductor CD1 is disposed on the first element body layer ML1 along the substantially outer peripheral edge of the first element body layer ML1. One end of the first coil conductor CD1 is provided with a via conductor (not shown in the drawing) so as to be connected to a first coil conductor CD1 that is provided on a first element body layer ML1 of the lamination group G5, and the other end of the first coil conductor CD1 is provided with a second through-hole conductor (not shown in the drawing) so as to be electrically connected to the second outer electrode E2.

The third through-hole conductor T3 of the lamination group G4 connects the third through-hole conductors T3 of the lamination groups G3 and G5, which are disposed adjacent to the lamination group G4 in the lamination direction, and is electrically conducted to the third outer electrode E3. Accordingly, the third through-hole conductor T3 may be disposed at a corner portion of the first element body layer ML1, which is located above the third outer electrode E3.

The fourth through-hole conductor T4 of the lamination group G4 connects the fourth through-hole conductors T4 of the lamination groups G3 and G5, which are disposed adjacent to the lamination group G4 in the lamination direction, and is electrically conducted to the fourth outer electrode E4. Accordingly, the fourth through-hole conductor T4 may be disposed at a corner portion of the first element body layer ML1, which is located above the fourth outer electrode E4.

### (Lamination Group G5)

The lamination group G5 forming the first element body portion 10a is provided with a first element body layer ML1, a first coil conductor CD1, a second through-hole conductor T2, the third through-hole conductor T3, and the fourth through-hole conductor T4, the first coil conductor CD1 forming a portion of the first coil C1 provided in the first element body layer ML1, the second through-hole conductor T2, the third through-hole conductor T3, and the fourth through-hole conductor T4 being provided in the first element body layer ML1.

The first coil conductor CD1 of the lamination group G5 forms the other turn of the first coil C1. More specifically, the first coil conductor CD1 is disposed on the first element body layer ML1 along the substantially outer peripheral edge of the first element body layer ML1. One end of the first coil conductor CD1 is connected to the first coil conductor CD1 that is provided on the first element body layer ML1 of the lamination group G4, and the other end of the first coil conductor CD1 is provided with a first through-hole conductor (not shown in the drawing) so as to be electrically connected to the first outer electrode E1.

The second through-hole conductor T2 of the lamination group G5 connects the second through-hole conductors T2 of the lamination groups G4 and G6, which are disposed adjacent to the lamination group G5 in the lamination direction, and is electrically conducted to the second outer electrode E2. The second through-hole conductor T2 may be disposed at a corner portion of the first element body layer ML1, which is located above the second outer electrode E2.

The third through-hole conductor T3 of the lamination group G5 connects the third through-hole conductors T3 of the lamination groups G4 and G6, which are disposed adjacent to the lamination group G5 in the lamination direction, and is electrically conducted to the third outer electrode E3. The third through-hole conductor T3 may be disposed at a corner portion of the first element body layer ML1, which is located above the third outer electrode E3.

The fourth through-hole conductor T4 of the lamination group G5 connects the fourth through-hole conductors T4 of the lamination groups G4 and G6, which are disposed adjacent to the lamination group G5 in the lamination direction, and is electrically conducted to the fourth outer electrode E4. The fourth through-hole conductor T4 may be disposed at a corner portion of the first element body layer ML1, which is located above the fourth outer electrode E4.

### (Lamination Group G6)

The lamination group G6 forming the first element body portion 10a is provided with a first through-hole conductor T1, the second through-hole conductor T2, the third through-hole conductor T3, and the fourth through-hole conductor T4 at corner portions of a first element body layer ML1. The first through-hole conductor T1 to the fourth through-hole conductors T4 of the lamination groups G1 to G6 have substantially the same area as viewed in plan view from the lamination direction.

### (Lamination Group G7)

The lamination group G7 forming the second element body portion 10b is provided with the first outer electrode E1 to the fourth outer electrode E4 at corner portions of a second element body layer ML2, the first outer electrode E1 to the fourth outer electrode E4 having a larger planar area than the first through-hole conductor T1 to the fourth through-hole conductor T4 of the lamination group G6 as viewed in plan view. By setting the planar area of the first outer electrode E1 to the fourth outer electrode E4 of the lamination group G7 to be larger than the planar area of the first through-hole conductor T1 to the fourth through-hole conductor T4 of the lamination group G6, the strength of the first outer electrode E1 to the fourth outer electrode E4 can be increased in a mounted state. In this specification, “through-hole conductor” and “outer electrode” are distinct members. The outer electrode is intended to be an electrode having a plane size substantially equal to the size of a mounting surface, and is not intended to be a member that includes the through-hole conductor.

The first coil conductors CD1 and the second coil conductors CD2 of the respective lamination groups may have the same thicknesses. As a material of the first coil conductor CD1 and the second coil conductor CD2, for example, a metal conductor, such as Ag, Cu, Au, Ni, or an alloy thereof is used. Each of the first coil conductor CD1 and the second coil conductor CD2 may be formed by printing a conductive paste on the above-described element body layer, for example.

A material of the first through-hole conductor T1 to the fourth through-hole conductor T4 and the via conductor may be, for example, a metal conductor, such as Ag or Cu. The material of the first through-hole conductor T1 to the fourth through-hole conductor T4 and the via conductor may be the same as, or may be different from, the above-described material of the first coil conductor CD1 and second coil conductor CD2. When the material of the first through-hole conductor T1 to the fourth through-hole conductor T4 has the same composition as the material of the coil conductors, the preparation for a conductive material can be simplified, thereby allowing the inductor to be manufactured easily. Each of the through-hole conductor and the via conductor may be formed, for example, by forming a through-hole in the above-described element body layer, and by printing a conductive paste into the through-hole. After the conductive paste is printed, the element body layer may be formed, by printing, in a region outside the conductive paste.

As described above, when the element body 10 has the laminated structure including the lamination groups G1 to G7, the degree of freedom in design of the inductor 1 is further increased. For example, in a case of manufacturing the inductor 1 in which the bottom surface (the first main surface 11) of the element body 10 includes the first outer electrode E1, the second outer electrode E2, the third outer electrode E3, and the fourth outer electrode E4, the first coil C1 and the second coil C2 can be easily led out to the bottom surface side. The above-mentioned laminated structure including the lamination groups G1 to G7 may be formed by sequentially stacking, by printing (screen printing or the like, for example), a material of the element body layer, a material of an insulator, a material of the coil conductor CD, and a material of the through-hole conductor and the via conductor, from the second main surface 12 side or the first main surface 11 side of the element body 10. In this case, for each of the lamination groups G1 to G7, printing may be repeatedly performed until the element body layer, the insulator, the coil conductor, the through-hole conductor, and the via conductor have desired thicknesses.

### First Element Body Portion

The first element body portion 10a is formed by laminating the first element body layers ML1. The first element body layer ML1 contains first powder particles MP1 made of a magnetic material (see FIG. 4). The first powder particles MP1 contain Fe (iron). More specifically, the first powder particles MP1 may be Fe particles or Fe alloy particles. An Fe alloy may be an Fe—Si-based alloy, an Fe—Si—Cr (Chromium)-based alloy, an Fe—Si—Al (aluminum)-based alloy, an Fe—Si—B (boron)-P (phosphorus)-Cu (copper)-C (carbon)-based alloy, an Fe—Si—B—Nb (niobium)-Cu-based alloy, or other alloys. The first powder particles MP1 may contain impurities that are not intentionally added during manufacture, such as Cr, Mn (manganese), Cu, Ni (nickel), P, S (sulfur), or Co (cobalt). Although the details will be described in a description of a manufacturing method, the first powder particles MP1 may be contained in a paste that contains a resin. Therefore, the first powder particles MP1 may contain elements that are more likely to be oxidized than Fe that is added when the paste is prepared (for example, Cr, Al, Li (lithium), Zn (zinc), Zr (zirconium), and oxide components thereof)). By causing the first powder particles to contain Si, oxidation of an Fe element contained in the powder particles can be suppressed, and the magnetic permeability of the inductor 1 can thereby be further increased. The resin component contained in a magnetic paste may be eliminated by performing a first heat treatment step for an element body, which will be described later.

The surface of each first powder particle MP1 is covered by an insulating film (not shown in the drawing). In this specification, “insulating property” is intended to refer to a volume resistivity of 1 MΩcm or more. When the surface of each first powder particle MP1 is covered by the insulating film, the insulating property between the first powder particles MP1 can be increased. As a method for forming the insulating film on the surface of each first powder particle MP1, a sol-gel method, a mechanochemical method, or other methods may be used. A material of the insulating film may be an oxide of P, Si, or the like. The insulating film may be an oxide film formed by oxidation of the surface of each first powder particle MP1. The thickness of the insulating film may be preferably 1 nm or more and 50 nm or less (i.e., from 1 nm to 50 nm), more preferably 1 nm or more and 30 nm or less (i.e., from 1 nm to 30 nm), and further preferably 1 nm or more and 20 nm or less (i.e., from 1 nm to 20 nm). For example, a cross-section obtained by polishing an inductor specimen is photographed with a scanning electron microscope (SEM) or a transmission electron microscope (TEM), and the thickness of the insulating film covering the surface of the powder particle can be measured from the obtained SEM image.

The average particle size of the first powder particles MP1 is preferably more than 2 μm and 30 μm or less (i.e., from more than 2 μm to 30 μm), more preferably more than 2 μm and 20 μm or less (i.e., from more than 2 μm to 20 μm), and further preferably more than 2 μm and 10 μm or less (i.e., from more than 2 μm to 10 μm). The average particle size of the first powder particles MP1 can be measured by the procedure described below. An inductor specimen is cut to obtain a cross-section of the specimen. To be more specific, the inductor specimen is cut along a plane passing through the winding axis of the coils of the element body and being orthogonal to the mounting surface and the end surface of the element body, thereby obtaining a cross-section of the specimen. The obtained cross-section is photographed with an SEM in regions (for example, 130 μm×100 μm) at a plurality of positions (five positions, for example), and the obtained SEM images are analyzed using image analysis software (for example, image analysis software “Win R00F” (made by MITANI CORPORATION)) to obtain the equivalent circle diameters of the powder particles. The mean value of the obtained equivalent circle diameters is taken as the average particle size of the powder particles. In this specification, the average particle size may refer to average particle size D50 (a particle size at which the cumulative percentage on a volume basis is 50%).

The first element body portion 10a described above contains powder particles and a resin resulting from resin impregnation, which will be described later. To be more specific, by performing the first heat treatment step for the element body, which will be described later, a resin component derived from a resin paste is reduced (or eliminated), and thereby adjacent powder particles are coupled via the insulating films of the powder particles (the insulating films come into direct contact with each other without another member being interposed therebetween). However, by the resin impregnation performed thereafter, gaps formed between the insulating films of adjacent powder particles in the element body are impregnated with resin, and therefore the element body contains a resin component. As a result, the first element body portion 10a has the first coefficient of linear expansion as a coefficient of linear expansion.

The first coil C1 and the second coil C2 are provided in the first element body portion 10a. The first coil C1 and the second coil C2 may be magnetically coupled to each other. For example, the coupling coefficient between the first coil C1 and the second coil C2 is 0.1 or more and 0.8 or less (i.e., from 0.1 to 0.8). Two coils consisting of the first coil C1 and the second coil C2 may be provided in the element body 10, or three or more coils including the first coil C1 and the second coil C2 may be provided in the element body 10.

### (First Coil)

The first coil C1 is provided in the first element body portion 10a. The first coil C1 includes the plurality of first coil conductors CD1, the first through-hole conductor T1, and the second through-hole conductor T2, the plurality of first coil conductors CD1 being connected to each other via the via conductor V (see FIG. 3).

The first through-hole conductor T1 electrically connects the end portion of the first coil conductor CD1 of the first coil C1 to the first outer electrode E1, the first coil conductor CD1 being located closest to the bottom surface (the first main surface 11) of the element body 10. The first through-hole conductor T1 extends in the lamination direction of metal magnetic layers (for example, the height direction T of the element body). The first through-hole conductor T1 may have a laminated structure.

The second through-hole conductor T2 electrically connects the other end portion of the first coil C1 to the second outer electrode E2. The second through-hole conductor T2 extends in the lamination direction of the metal magnetic layers (for example, the height direction T of the element body). The second through-hole conductor T2 may have a laminated structure.

### (Second Coil)

The second coil C2 may be stacked above the first coil C1 in the lamination direction within the first element body portion 10a. The second coil C2 may include the plurality of second coil conductors CD2, the third through-hole conductor T3, and the fourth through-hole conductor T4, the plurality of second coil conductors CD2 being connected to each other via the via conductor (not shown in the drawing).

The third through-hole conductor T3 may electrically connect the end portion of a second wound portion of the second coil C2 to the third outer electrode E3, the second wound portion being located closest to the bottom surface (the first main surface 11) of the element body 10. The third through-hole conductor T3 may extend in the lamination direction of the metal magnetic layers (for example, the height direction T of the element body). The third through-hole conductor T3 may have a laminated structure.

The fourth through-hole conductor T4 may connect the other end portion of the second coil C2 to the fourth outer electrode E4. The fourth through-hole conductor T4 may extend in the lamination direction of the metal magnetic layers (for example, the height direction T of the element body). The fourth through-hole conductor T4 may have a laminated structure.

### Second Element Body Portion

The second element body portion 10b is provided on the first main surface 11 and/or the second main surface 12, the first main surface 11 facing the lower surface of the coil (the first coil C1) of the first element body portion 10a, the second main surface 12 being opposed to the first main surface 11. In the present embodiment, the first main surface 11 and the second main surface 12 may be disposed on the extension of the winding axis of the coils. FIG. 3 shows the inductor of the first embodiment in a mode in which the second element body portion 10b is provided on the mounting surface (in FIG. 1, the first main surface 11) side of the element body 10, and the outer electrodes E are disposed in the second element body portion 10b. With such a mode, the strength of the element body 10 can be increased, and the fixing strength of the outer electrodes E to the element body 10 can be increased.

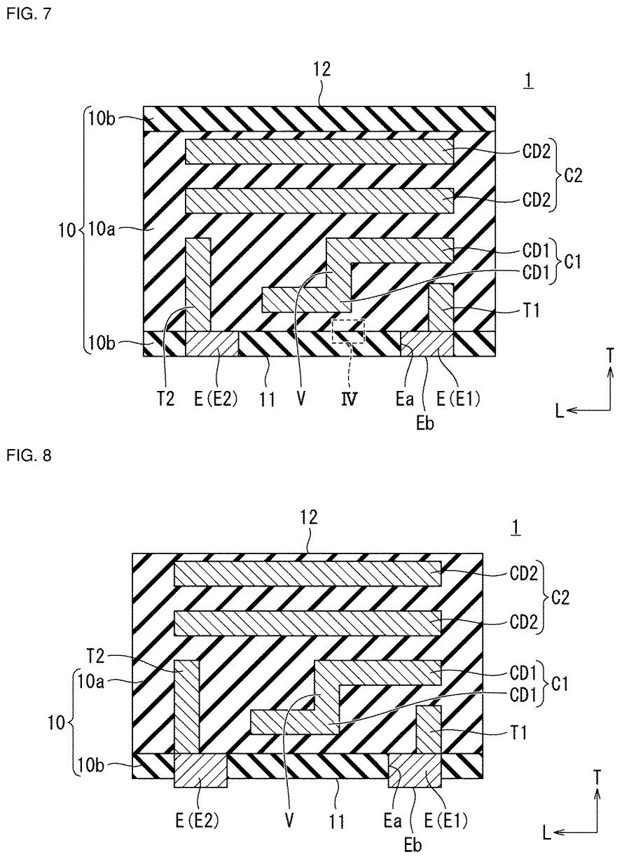

The second element body portion 10b may be provided at a position on the top surface side (in FIG. 1, the second main surface 12 side) of the element body 10 as shown in FIG. 6, or the second element body portions 10b may be provided on both main surface sides (in FIG. 1, both the first main surface 11 side and the second main surface 12 side) of the element body 10 as shown in FIG. 7. Hereinafter, the mode shown in FIG. 3 will be mainly described in detail.

The second element body portion 10b is formed of the second element body layer ML2. The second element body layer ML2 contains second powder particles MP2 (see FIG. 4). The second powder particles MP2 in the second element body portion 10b may have the same composition as the first powder particles MP1 in the first element body portion 10a. By causing the second powder particles MP2 and the first powder particles MP1 to have the same composition, preparation of powder particles can be simplified, and therefore the inductor can be manufactured easily.

The second powder particles MP2 in the second element body portion 10b may have a composition different from that of the first powder particles MP1 in the first element body portion 10a. For example, the second powder particles MP2 may be formed of a magnetic powder such as ferrite or metal magnetic powder, a glass powder such as fused silica powder or high melting point glass powder, a nonmagnetic powder, or an alumina powder.

As a characteristic configuration of the present disclosure, the second element body portion 10b has, as the value of a coefficient of linear expansion, the second coefficient of linear expansion that is lower than the first coefficient of linear expansion. Hereinafter, a method for setting the coefficient of linear expansion of the second element body portion 10b to the second coefficient of linear expansion will be described.

One method for achieving the second coefficient of linear expansion is to set the amount of the resin component in the second element body portion 10b to be smaller than the amount of the resin component in the first element body portion 10a. An example of such a method is to set the amount of a resin component that enters the second element body portion 10b through resin impregnation, which will be described later, to be smaller than the amount of a resin component that enters the first element body portion 10a through resin impregnation. More specifically, for the resin component contained in the magnetic paste, by setting the amount of the resin component in the second element body portion 10b to be smaller than the amount of the resin component in the first element body portion 10a, the region where the resin component is eliminated is adjusted by the first heat treatment step, which will be described later. Consequently, through resin impregnation performed thereafter, the amount of the resin component in the second element body portion 10b can be set to be smaller than the amount of the resin component in the first element body portion 10a. In general, it is known that the coefficient of linear expansion of resin is higher than the coefficient of linear expansion (approximately 12 ppm/K) of powder particles containing Fe. Accordingly, by setting the amount of the resin component in the second element body portion 10b to be smaller than the amount of the resin component in the first element body portion 10a, the coefficient of linear expansion of the second element body portion 10b can be made lower than the coefficient of linear expansion of the first element body portion 10a.

Another method for achieving the second coefficient of linear expansion is to set the volume of the resin per unit volume of a region between a plurality of second powder particles MP2 in the second element body portion 10b to be smaller than the volume of the resin per unit volume of a region between a plurality of first powder particles MP1 in the first element body portion 10a. Also with the above-mentioned method, the amount of the resin in the region between the second powder particles MP2 in the second element body portion 10b can be made smaller than the amount of the resin in the region between the first powder particles MP1 in the first element body portion 10a, and thereby the coefficient of linear expansion of the second element body portion 10b can be made lower than the coefficient of linear expansion of the first element body portion 10a. Consequently, in the element body 10, a compressive stress acts from the second element body portion 10b toward the first element body portion 10a, and, conversely, a force that cancels this compressive stress acts from the first element body portion 10a toward the second element body portion 10b, and therefore the strength of the element body 10 can be increased.

Still another method for achieving the second coefficient of linear expansion is to set the coefficient of linear expansion of the second powder particles MP2 in the second element body portion 10b to be lower than the coefficient of linear expansion of the first powder particles MP1 in the first element body portion 10a. In a case in which metal magnetic powder containing Fe is used as the first powder particles MP1, the coefficient of linear expansion of the powder particles containing Fe is approximately 12 ppm/K and hence, a material having a coefficient of linear expansion lower than this numerical value is used as the second powder particles MP2. For example, for the second powder particles MP2, alumina (Al₂O₃, coefficient of linear expansion: 6 to 7 ppm/K), fused silica (coefficient of linear expansion: 0.5 to 1 ppm/K), high melting point glass (coefficient of linear expansion: approximately 9 ppm/K), and/or ferrite having a coefficient of linear expansion of less than 12 ppm/K may be used. The relationship of coefficient of linear expansion of second element body portion 10b<coefficient of linear expansion of first element body portion 10a may be achieved by making the second element body portion 10b and the first element body portion 10a contain a resin having a higher coefficient of linear expansion than the powder particles, and by controlling the resin contents. For example, when the resin contents are controlled, ferrite having a coefficient of linear expansion of 12 ppm/K or more may be used for the second powder particles MP2 (that is, a material having a higher coefficient of linear expansion than the first powder particles MP1 may be used as the second powder particles MP2). Consequently, the strength of the second element body portion 10b can be made higher than the strength of the first element body portion 10a.

As an example of the second powder particles MP2, when the first powder particles MP1 are formed of a metal magnetic powder, the second powder particles MP2 may contain one selected from the group consisting of a ferrite powder, a nonmagnetic powder, a glass powder, and an alumina powder. That is, the coefficient of linear expansion of the second element body portion 10b may be made lower than the coefficient of linear expansion of the first element body portion 10a by controlling increases or decreases in the coefficients of linear expansion of the first element body portion 10a and the second element body portion 10b through adjustment of the coefficients of linear expansion of the resin and the powder particles contained in the first element body portion 10a and the second element body portion 10b. Consequently, the strength of the second element body portion 10b can be made higher than the strength of the first element body portion 10a.

As an example of the second powder particles MP2, when the first powder particles MP1 are formed of a ferrite powder, the second powder particles MP2 may contain one selected from the group consisting of a metal magnetic powder, a nonmagnetic powder, and a glass powder. That is, the coefficient of linear expansion of the second element body portion 10b may be made lower than the coefficient of linear expansion of the first element body portion 10a by controlling increases or decreases in the coefficients of linear expansion of the first element body portion 10a and the second element body portion 10b through adjustment of the coefficients of linear expansion of the resin and the powder particles contained in the first element body portion 10a and the second element body portion 10b. Consequently, the strength of the second element body portion 10b can be made higher than the strength of the first element body portion 10a.

In this specification, a method for measuring a coefficient of linear expansion is as follows. First, a measurement sample is prepared by extracting the first element body portion 10a of the element body 10 of the inductor. Specifically, the measurement sample of the first element body portion 10a is obtained by cutting out, along the winding axis of the coils, the center portion of the cross-section of the specimen into a columnar shape having a depth from the surface toward the side surface of the element body 10, the cross-section of the specimen being obtained by cutting the specimen along a plane passing through the winding axis of the coils of the element body 10 and being orthogonal to the mounting surface and the end surface of the element body 10. In extracting the first element body portion 10a, it is desirable to extract, as a measurement sample, a portion containing powder particles and a resin while excluding the coils and the through-hole conductor portions. A dimensional change in the length of this measurement sample, based on the length at a normal temperature (20° C.), is continuously measured with a TMA device (model number TMA7100 made by Hitachi High-Tech Corporation) over a temperature range from room temperature to 200° C., and a coefficient of linear expansion is obtained from the obtained expansion curve. To obtain a coefficient of linear expansion, it is sufficient to obtain a dimensional change over a predetermined temperature range. For example, a measuring microscope equipped with a heating device, an environmental SEM (for example, an environmental scanning electron microscope (ESEM)), or the like may be used, and the means is not particularly limited. Then, by comparing the length of measurement sample at 20° C. with the length of the measurement sample at 200° C., the coefficient of linear expansion of the first element body portion 10a can be calculated. To measure the coefficient of linear expansion of the second element body portion 10b, a measurement sample is prepared in the same manner as described above. The measurement sample is prepared by extracting the second element body portion 10b of the element body 10, and the length of the measurement sample at 20° C. is compared with the length of the measurement sample at 200° C. using the TMA device (model number TMA7100 made by Hitachi High-Tech Corporation). With such operations, the coefficient of linear expansion of the second element body portion 10b can be calculated.

The second element body portion 10b described above contains powder particles and a resin derived from the paste, and has, as the value of a coefficient of linear expansion, the second coefficient of linear expansion that is lower than the first coefficient of linear expansion.

### Outer Electrode

The outer electrodes E are provided in or on the bottom surface of the element body 10. The outer electrodes E include the first outer electrode E1, the second outer electrode E2, the third outer electrode E3, and the fourth outer electrode E4. The first outer electrode E1 and the second outer electrode E2 may be electrically connected to the first coil C1. The third outer electrode E3 and the fourth outer electrode E4 may be electrically connected to the second coil C2. By providing the outer electrodes E in or on the bottom surface (the first main surface 11) of the element body 10, the inductor 1 can be appropriately mounted on a mounting board or the like.

For example, a material, such as Ag or Cu, may be used for the outer electrodes E. The outer electrodes E may have one layer, or may have a laminated structure including two or more layers. The outer electrodes E may be formed by any method and, in the same manner as the formation of the coil conductors CD described above, the outer electrodes E may be formed using a conductive paste.

As a preferred embodiment of the outer electrode E, side surfaces Ea of each outer electrode E may be covered by the second element body portion 10b, and a mounting surface Eb of each outer electrode E may be exposed from the second element body portion 10b (see FIG. 3). With such a configuration, the surfaces of the outer electrodes E other than the mounting surfaces Eb are disposed in the second element body portion 10b. Accordingly, the outer electrodes E having relatively high strength can be preferably disposed in the second element body portion 10b, and therefore the strength of the second element body portion 10b can be further increased.

As a preferred embodiment of the outer electrodes E, the coefficient of linear expansion of the outer electrodes E may be lower than the coefficient of linear expansion of the first element body portion 10a. With such a configuration, the strength of the second element body portion 10b that includes the outer electrodes E can be made higher than the strength of the first element body portion 10a.

As described above, the inductor of the present disclosure includes the element body 10 including the first element body portion 10a and the second element body portion 10b. There may be cases in which an unintentional impact is applied to a mounting board MB, thus causing deflection deformation as shown in FIG. 5, for example, in a state in which the inductor is bonded to a wiring pattern of the mounting board MB by soldering, or in which the inductor is incorporated in a board not shown in the drawing and external terminals are connected to a layer of the board, the layer MB including wiring. However, even in such a case, in the element body 10, the second element body portion 10b is provided on the first main surface 11 side (or the second main surface 12 side, or both the first main surface 11 side and the second main surface 12 side) of the element body 10, the first main surface 11 side being likely to receive stress caused by the deflection deformation. Further, the coefficient of linear expansion of the second element body portion 10b is lower than the coefficient of linear expansion of the first element body portion 10a. Accordingly, the strength can be effectively increased at a portion (the first main surface 11 side and/or the second main surface 12 side of the element body 10) that is likely to receive stress caused by deflection deformation.

In the inductor of the present disclosure, a compressive stress may be generated in the second element body portion 10b. With such a configuration, the compressive stress acts to generate tensile stress in the first element body portion 10a, and acts to generate compressive stress in the second element body portion 10b, which acts against the tensile stress generated in the first element body portion 10a. Therefore, the strength of the element body 10 is further increased as a whole. The above-described compressive stress may be generated in the element body 10 even in a state in which the inductor of the present disclosure is not mounted on the mounting board MB shown in FIG. 5.

In the inductor of the present disclosure, the second element body portion 10b may be provided on the second main surface 12 side of the element body 10 as shown in FIG. 6, or the second element body portions 10b may be provided on both the first main surface 11 side and the second main surface 12 side of the element body 10 as shown in FIG. 7. Even with the mode shown in FIG. 6 or FIG. 7, the strength can be effectively increased at a portion that is likely to receive stress caused by deflection deformation (the first main surface 11 side and/or the second main surface 12 side of the element body 10).

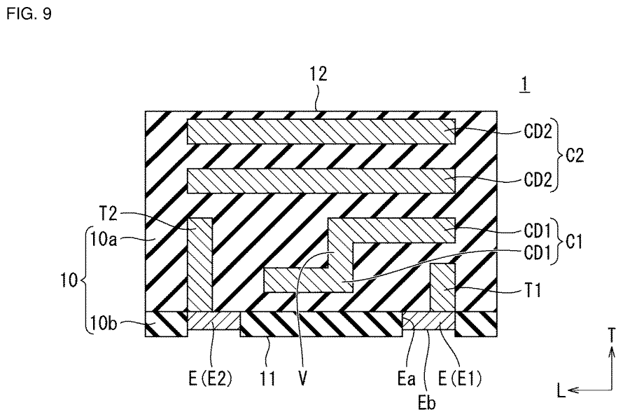

In the inductor of the first embodiment, as shown in FIG. 8, the mounting surfaces Eb of the outer electrodes E may protrude from the second element body portion 10b. By forming the outer electrodes in this manner, a mounting position in the height direction can be adjusted. In a case in which the mounting surfaces Eb of the outer electrodes E protrude from the second element body portion 10b, when the inductor is mounted on the mounting board, solder can be disposed between wiring of the mounting board and the side surfaces of the outer electrodes, and therefore the fixing strength of the inductor to the mounting board can be increased. In contrast to the inductor shown in FIG. 8, as shown in FIG. 9, the mounting surfaces Eb of the outer electrodes E may be exposed in a state of being recessed from the second element body portion 10b.

### Inductor of Second Embodiment

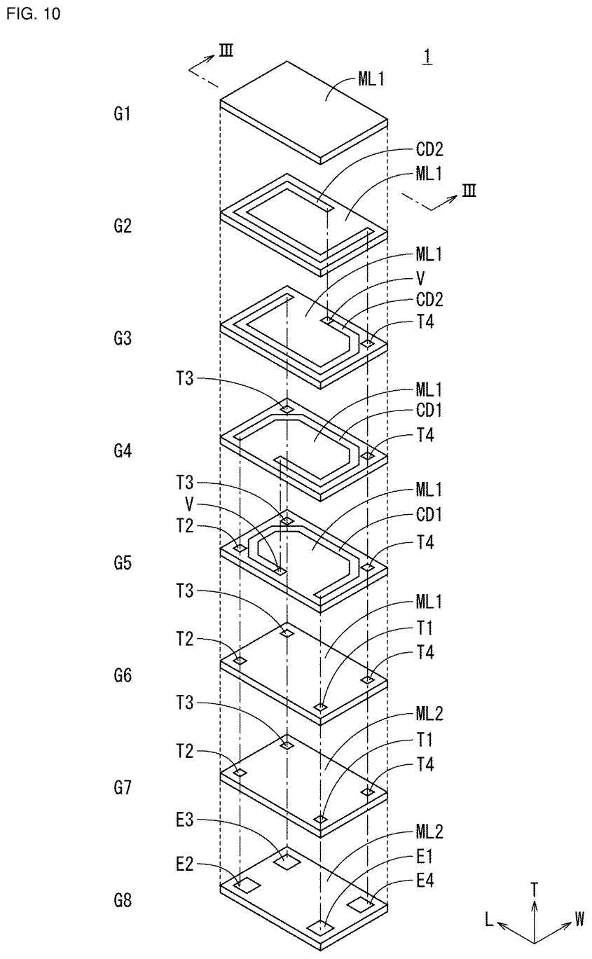

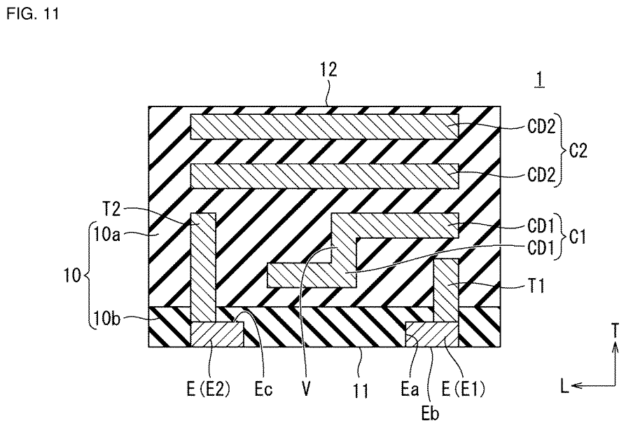

An inductor of a second embodiment will be described with reference to FIG. 10 and FIG. 11. FIG. 10 is an exploded perspective view of the inductor of the second embodiment, and FIG. 11 is a sectional view of the inductor of the second embodiment. In the description of the inductor of the second embodiment, a description of configurations that are the same as those of the inductor of the first embodiment will be omitted as appropriate. That is, configurations different from those of the inductor of the first embodiment will be mainly described below.

### Element Body

Lamination groups G1 to G6 forming an element body 10 are the same as those of the above-described inductor of the first embodiment, and form a first element body portion 10a of the element body 10. In contrast, lamination groups G7 and G8 of the inductor of the second embodiment form a second element body portion 10b of the element body 10.

### (Lamination Group G7)

The lamination group G7 that forms the second element body portion 10b is provided with a first through-hole conductor T1, a second through-hole conductor T2, a third through-hole conductor T3, and a fourth through-hole conductor T4 at corner portions of a second element body layer ML2. The first through-hole conductors T1 to the fourth through-hole conductors T4 of the lamination groups G1 to G7 have substantially the same area as viewed in plan view from the lamination direction.

### (Lamination Group G8)

The lamination group G8 that forms the second element body portion 10b is provided with a first outer electrode E1 to a fourth outer electrode E4 at corner portions of a second element body layer ML2, the first outer electrode E1 to the fourth outer electrode E4 having a larger planar area than the first through-hole conductor T1 to the fourth through-hole conductor T4 of the lamination group G7 as viewed in plan view. By setting the planar area of the first outer electrode E1 to the fourth outer electrode E4 of the lamination group G8 to be larger than the planar area of the first through-hole conductor T1 to the fourth through-hole conductor T4 of the lamination group G7, the strength of the first outer electrode E1 to the fourth outer electrode E4 can be increased in a mounted state.

By forming the lamination groups G7 and G8 as described above, in the inductor 1 of the second embodiment, surfaces Ec (see FIG. 11) of the outer electrodes E that are opposed to the mounting surface are disposed in the second element body portion 10b. With such a configuration, the outer electrodes E are completely embedded in the second element body portion 10b, and therefore the strength of the outer electrodes E relative to the element body can be further increased.

In the inductor 1 of the second embodiment, the thickness of the outer electrodes E is smaller than the thickness of the second element body portion 10b. Also with such a configuration, the outer electrodes E are completely embedded in the second element body portion 10b, and therefore the strength of the outer electrodes E relative to the element body can be further increased.

### Inductor of Third Embodiment

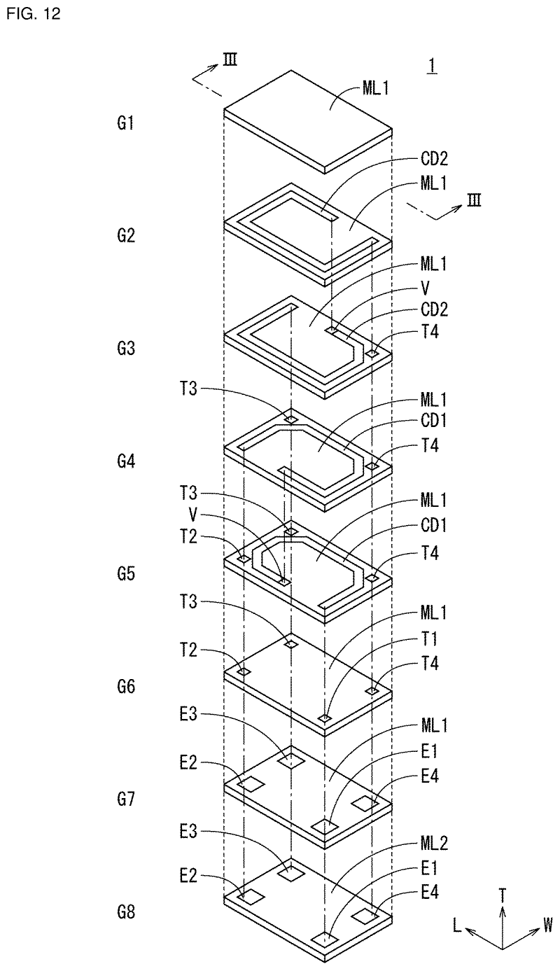

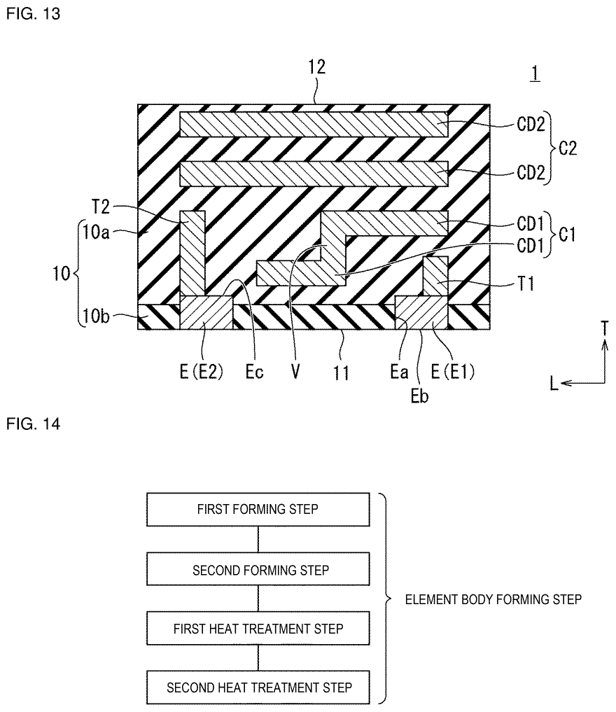

An inductor of a third embodiment will be described with reference to FIG. 12 and FIG. 13. FIG. 12 is an exploded perspective view of the inductor of the third embodiment, and FIG. 13 is a sectional view of the inductor of the third embodiment. In the description of the inductor of the third embodiment, a description of configurations that are the same as those of the inductor of the first embodiment will be omitted as appropriate. That is, configurations different from those of the inductor of the first embodiment will be mainly described below.

### Element Body

Lamination groups G1 to G6 forming an element body 10 are the same as those of the above-described inductor of the first embodiment, and form a first element body portion 10a of the element body 10. A lamination group G7 of the inductor of the third embodiment forms the first element body portion 10a of the element body 10. In contrast, a lamination group G8 of the inductor of the third embodiment forms a second element body portion 10b of the element body 10.

### (Lamination Group G7)

The lamination group G7 that forms the first element body portion 10a is provided with a first outer electrode E1 to a fourth outer electrode E4 at corner portions of a first element body layer ML1, the first outer electrode E1 to the fourth outer electrode E4 having a larger planar area than the first through-hole conductor T1 to the fourth through-hole conductor T4 of the lamination group G6 as viewed in plan view. That is, the first outer electrode E1 to the fourth outer electrode E4 of the lamination group G7 are formed to have a larger planar area than the first through-hole conductor T1 to the fourth through-hole conductor T4 of the lamination group G6.

### (Lamination Group G8)

The lamination group G8 that forms the second element body portion 10b is provided with a first outer electrode E1 to a fourth outer electrode E4 at corner portions of a second element body layer ML2, the first outer electrode E1 to the fourth outer electrode E4 of the lamination group G8 having substantially the same planar area as the first outer electrode E1 to the fourth outer electrode E4 of the lamination group G7 as viewed in plan view.

By forming the lamination groups G7 and G8 as described above, in the inductor 1 of the third embodiment, surfaces Ec (see FIG. 13) of the outer electrodes E that are opposed to the mounting surface are disposed in the first element body portion 10a.

In the inductor 1 of the third embodiment, the thickness of the outer electrodes E is larger than the thickness of the second element body portion 10b. With such a configuration, the outer electrodes E have an increased thickness, and therefore the strength of the outer electrodes E can be further increased in a mounted state.

### <Method for Manufacturing Inductor of Present Disclosure>

Next, a method for manufacturing an inductor of the present disclosure will be described with reference to FIG. 14. The method for manufacturing an inductor of the present disclosure includes an element body forming step. Hereinafter, the method for manufacturing an inductor of the present disclosure will be described assuming the inductor of the first embodiment shown in FIG. 2 and FIG. 3.

### Element Body Forming Step

The element body forming step includes a first forming step, a second forming step, a first heat treatment step, and a second heat treatment step.

### First Forming Step

The first forming step is a step of forming a precursor of a first element body portion incorporating coils and having a first coefficient of linear expansion. First, a paste for forming first element body layers ML1 of lamination groups G1 to G6 described with reference to FIG. 2, and a conductive paste for forming coil conductors CD are prepared.

As an example of a method for preparing a paste for forming the first element body layers ML1, metal powder, such as an Fe—Si alloy or an Fe—Si—Cr alloy, having D50 of 2 μm or more and 20 μm or less (i.e., from 2 μm to 20 μm) is prepared, D50 being a particle size at which the cumulative percentage on a volume basis is 50%. Cellulose, polyvinyl butyral (PVB), or the like as a binder, and a mixture of terpineol and butyl diglycol acetate (BCA) or the like as a solvent are added to this metal powder, and the metal powder is then kneaded to prepare a magnetic paste.

When an Fe—Si alloy is used as a metal magnetic material, it is preferable that a Si content be 2.0 at % or more and 8.0 at % or less (i.e., from 2.0 at % to 8.0 at %). When an Fe—Si—Cr alloy is used as metal magnetic powder, it is preferable that the Si content be 2.0 at % or more and 8.0 at % or less (i.e., from 2.0 at % to 8.0 at %). When an Fe—Si—Cr alloy is used as iron powder, it is preferable that a Cr content be 0.2 at % or more and 6.0 at % or less (i.e., from 0.2 at % to 6.0 at %).

For the conductive paste, for example, a paste containing Ag as a conductive material is prepared.

Lamination groups G1 to G6 shown in FIG. 2 are prepared by screen printing or the like using the above-described magnetic paste and conductive paste, and these lamination groups G1 to G6 are then laminated to form a precursor of the first element body portion.

### Second Forming Step

The second forming step is a step of forming a precursor of a second element body portion having a second coefficient of linear expansion that is lower than a first coefficient of linear expansion. First, a paste for forming a second element body layer ML2 of a lamination group G7 described with reference to FIG. 2, and a conductive paste for forming outer electrodes are prepared.

For the paste for forming the second element body layer ML2, the same material as the paste for forming the first element body layer ML1 may be used, or a paste material different from the paste for forming the first element body layer ML1 may be used.

For the paste for forming the second element body layer ML2, a method for setting the coefficient of linear expansion of the paste to be lower than the coefficient of linear expansion of the first element body portion 10a is adopted. To be more specific, the following method is adopted, such as a method for setting the amount of the resin component in the second element body portion 10b to be smaller than the amount of the resin component in the first element body portion 10a, a method for setting the volume of a resin per unit volume of a region between a plurality of second powder particles MP2 in the second element body portion 10b to be smaller than the volume of a resin per unit volume of a region between a plurality of first powder particles MP1 in the first element body portion 10a, and/or a method for setting the coefficient of linear expansion of the second powder particles MP2 in the second element body portion 10b to be lower than the coefficient of linear expansion of the first powder particles MP1 in the first element body portion 10a.

For the conductive paste for forming the outer electrodes, for example, a paste containing Ag as a conductive material is prepared.

The lamination group G7 shown in FIG. 2 is prepared by screen printing or the like using the above-described magnetic paste or conductive paste, and these lamination groups are laminated to form a precursor of the second element body portion.

As a more specific method for the second forming step, the second forming step may be performed such that the precursor of the first element body portion and the precursor of the second element body portion are successively laminated. For example, the precursor of the second element body portion may be successively laminated on the precursor of the first element body portion by screen printing. The precursor of the first element body portion may be successively laminated on the precursor of the second element body portion by screen printing. With such a method, the precursor of the first element body portion and the precursor of the second element body portion are successively laminated. Accordingly, screen printing can be efficiently performed, thereby simplifying the manufacturing process.

As another method for the second forming step, the second forming step may be performed such that, after the precursor of the second element body portion is formed separately from the precursor of the first element body portion, the precursor of the first element body portion and the precursor of the second element body portion, which are separately formed, are integrated together. With this method, a step of forming the precursor of the first element body portion can be performed separately from, and concurrently with, a step of forming the precursor of the second element body portion, and therefore a process time can be shortened.

### First Heat Treatment Step

After the precursor of the first element body portion and the precursor of the second element body portion are formed, degreasing to remove a binder contained in the paste is performed and thereafter, heat treatment is performed. By performing the heat treatment, an oxide film is formed on the surfaces of metal magnetic particles, and therefore the metal magnetic particles are coupled via the oxide films (the oxide films come into contact with each other without another member interposed therebetween), and the conductive material in the conductive paste is sintered. The heat treatment temperature may be set to, for example, approximately 700° C.

### Second Heat Treatment Step

After the first heat treatment step, the precursor of the first element body portion and the precursor of the second element body portion, on which the heat treatment is performed, are caused to be impregnated with a resin. Although an epoxy resin is used as the resin with which the multilayer body is impregnated, one or more kinds of resin selected from the group consisting of a phenol resin, a polyester resin, a polyimide resin, a polyolefin resin, a silicone resin, an acrylic resin, a polyvinyl butyral resin, a cellulose resin, an alkyd resin, and other resins may be used. With such an operation, a resin component resulting from impregnation enters regions in which a resin component derived from the magnetic paste is eliminated by the first heat treatment step, and therefore the amount of the resin component in the second element body portion can be made smaller than the amount of the resin component in the first element body portion. After the resin impregnation, heat treatment is performed again. The heat treatment temperature in the second heat treatment step may be set to, for example, approximately 80° C. to 300° C. By performing the above-mentioned steps, it is possible to obtain an element body including the first element body portion and the second element body portion, containing powder particles and a resin, and incorporating the coils, the first element body portion having the first coefficient of linear expansion, the second element body portion having the second coefficient of linear expansion. After the second heat treatment step, the temperature of the element body decreases to approximately room temperature, thereby generating a compressive stress from the second element body portion toward the first element body portion.

In a case of forming an element body as shown in FIG. 8, in which the outer electrodes E protrude from the second element body portion 10b, after the lamination group G7 is formed, as the lamination group G8, a paste for forming the outer electrodes E may be formed by screen printing as a layer that is to be eliminated by performing heat treatment. By adding this lamination group, a layer for printing the outer electrodes E is eliminated, and therefore the outer electrodes E can be exposed from the element body 10 as shown in FIG. 8.

### Example

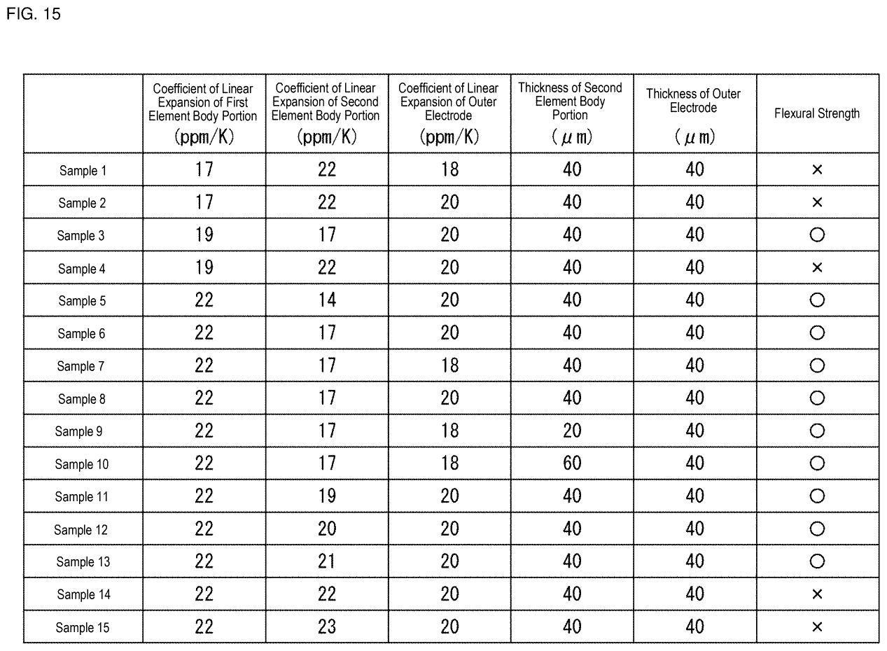

A verification test relating to the inductor of the present disclosure will be described in detail with reference to FIG. 15. To be more specific, inductors having the coefficients of linear expansion of the first element body portion and the coefficients of linear expansion of the second element body portion shown in FIG. 15 were manufactured, and the flexural strength of the inductors was evaluated.

The coefficients of linear expansion of the first element body portion and the second element body portion shown in FIG. 15 were calculated by, as described above, comparing the length of a measurement sample at 20° C. with the length of a measurement sample at 200° C. using the TMA device. The determination of flexural strength shown in FIG. 15 was made based on the measurement results of flexural strength obtained using a flexural strength measuring device (three-point bending device).

According to the determination results of flexural strength shown in FIG. 15, sample 3 and samples 5 to 13 had preferable flexural strength, sample 3 and samples 5 to 13 being samples in which the coefficient of linear expansion of the first element body portion is higher than the coefficient of linear expansion of the second element body portion. In contrast, samples 1, 2, 4, 14, and 15 had a lower flexural strength than sample 3 and samples 5 to 13, samples 1, 2, 4, 14, and 15 being samples in which the coefficient of linear expansion of the first element body portion is lower than the coefficient of linear expansion of the second element body portion.

It should be noted that the embodiments disclosed herein are merely illustrative in all respects and should not be construed as limiting. Accordingly, the technical scope of the present disclosure is not interpreted only by the above embodiments but is defined based on the description in Claims. Further, the technical scope of the present disclosure includes all modifications made within the meaning and scope equivalent to Claims.

Aspects of the inductor and the method for manufacturing an inductor of the present disclosure are as follows.
<1> An inductor including an element body containing powder particles and a resin, and incorporating a coil; and an outer electrode formed in or on the element body, and electrically connected to the coil. The element body includes a first element body portion incorporating the coil and having a first coefficient of linear expansion, and a second element body portion provided on a first main surface and/or a second main surface and having a second coefficient of linear expansion that is lower than the first coefficient of linear expansion. The first main surface faces a lower surface of the coil of the first element body portion, and the second main surface is opposed to the first main surface.
<2> The inductor according to <1>, in which the second element body portion is provided on a mounting surface side of the element body, and the outer electrode is disposed in the second element body portion.
<3> The inductor according to <1> or <2>, in which a side surface of the outer electrode is covered by the second element body portion, and a mounting surface of the outer electrode is exposed from the second element body portion.
<4> The inductor according to any one of <1> to <3>, in which a surface of the outer electrode that is opposed to a mounting surface of the outer electrode is disposed in the second element body portion.
<5> The inductor according to any one of <1> to <4>, in which a thickness of the outer electrode is smaller than a thickness of the second element body portion.
<6> The inductor according to any one of <1> to <4>, in which a surface of the outer electrode that is opposed to a mounting surface of the outer electrode is disposed in the first element body portion.
<7> The inductor according to any one of <1> to <4>, in which a thickness of the outer electrode is larger than a thickness of the second element body portion.
<8> The inductor according to any one of <1> to <7>, in which an amount of a resin component in the second element body portion is smaller than an amount of a resin component in the first element body portion.
<9> The inductor according to any one of <1> to <8>, in which a volume per unit volume of a region between a plurality of powder particles in the second element body portion is smaller than a volume per unit volume of a region between a plurality of powder particles in the first element body portion.
<10> The inductor according to any one of <1> to <9>, in which a coefficient of linear expansion of powder particles in the second element body portion is lower than a coefficient of linear expansion of powder particles in the first element body portion.
<11> The inductor according to any one of <1> to <9>, in which powder particles in the first element body portion has a same composition as powder particles in the second element body portion.
<12> The inductor according to any one of <1> to <9>, in which powder particles in the first element body portion are formed of a metal magnetic powder, and powder particles in the second element body portion contain one selected from the group consisting of a ferrite powder, a nonmagnetic powder, a glass powder, and an alumina powder.
<13> The inductor according to any one of <1> to <9>, in which powder particles in the first element body portion are formed of a ferrite powder, and powder particles in the second element body portion contain one selected from the group consisting of a metal magnetic powder, a nonmagnetic powder, and a glass powder.
<14> The inductor according to any one of <1> to <13>, in which a material of a through-hole has a same composition as a material of the coil, the through-hole electrically connecting the coil to the outer electrode.
<15> The inductor according to any one of <1> to <14>, in which a planar area of a through-hole as viewed in plan view is smaller than a planar area of the outer electrode as viewed in plan view, the through-hole electrically connecting the coil to the outer electrode.
<16> The inductor according to any one of <1> to <15>, in which a coefficient of linear expansion of the outer electrode is lower than a coefficient of linear expansion of the first element body portion.
<17> The inductor according to any one of <1> to <16>, in which a compressive stress is generated in the second element body portion.
<18> A method for manufacturing an inductor, the method comprising an element body forming step of forming an element body containing powder particles and a resin and incorporating a coil. The element body forming step includes a first forming step of forming a precursor of a first element body portion incorporating the coil and having a first coefficient of linear expansion, and a second forming step of forming a precursor of a second element body portion provided on a first main surface and/or a second main surface and having a second coefficient of linear expansion that is lower than the first coefficient of linear expansion. The first main surface faces a lower surface of the coil in the precursor of the first element body portion, and the second main surface is opposed to the first main surface. The element forming step further includes a first heat treatment step of performing heat treatment on the precursor of the first element body portion and on the precursor of the second element body portion, and a second heat treatment step of causing the precursor of the first element body portion and the precursor of the second element body portion, on which the heat treatment is performed, to be impregnated with the resin, and of performing heat treatment on the precursor of the first element body portion and the precursor of the second element body portion to obtain the element body including the first element body portion and the second element body portion, containing the powder particles and the resin, and incorporating the coil. The first element body portion has the first coefficient of linear expansion, and the second element body portion has the second coefficient of linear expansion.
<19> The method for manufacturing an inductor according to <18>, in which in the first forming step and the second forming step, the precursor of the first element body portion and the precursor of the second element body portion are successively laminated.
<20> The method for manufacturing an inductor according to <18>, in which in the second forming step, after the precursor of the second element body portion is formed separately from the precursor of the first element body portion, the precursor of the first element body portion and the precursor of the second element body portion, which are formed separately, are integrated together.

The inductor of the present disclosure can be preferably used as an electronic component in which an element body forming a magnetic body has higher strength.

What is claimed is:

1. An inductor comprising:
an element body including powder particles and a resin, and incorporating a coil; and
an outer electrode that is in or on the element body, and electrically connected to the coil, wherein
the element body includes
a first element body portion incorporating the coil and having a first coefficient of linear expansion, and
a second element body portion on at least one of a first main surface or a second main surface, and having a second coefficient of linear expansion that is lower than the first coefficient of linear expansion, the first main surface facing a lower surface of the coil of the first element body portion, and the second main surface being opposed to the first main surface.

2. The inductor according to claim 1, wherein
the second element body portion is on a mounting surface side of the element body, and
the outer electrode is in the second element body portion.

3. The inductor according to claim 1, wherein
a side surface of the outer electrode is covered by the second element body portion, and a mounting surface of the outer electrode is exposed from the second element body portion.

4. The inductor according to claim 1, wherein
a surface of the outer electrode that is opposed to a mounting surface of the outer electrode is in the second element body portion.

5. The inductor according to claim 1, wherein
a thickness of the outer electrode is smaller than a thickness of the second element body portion.

6. The inductor according to claim 1, wherein
a surface of the outer electrode that is opposed to a mounting surface of the outer electrode is in the first element body portion.

7. The inductor according to claim 1, wherein
a thickness of the outer electrode is larger than a thickness of the second element body portion.

8. The inductor according to claim 1, wherein
an amount of a resin component in the second element body portion is smaller than an amount of a resin component in the first element body portion.

9. The inductor according to claim 1, wherein
a volume of a resin per unit volume of a region between a plurality of powder particles in the second element body portion is smaller than a volume of a resin per unit volume of a region between a plurality of powder particles in the first element body portion.

10. The inductor according to claim 1, wherein
a coefficient of linear expansion of powder particles in the second element body portion is lower than a coefficient of linear expansion of powder particles in the first element body portion.

11. The inductor according to claim 1, wherein
powder particles in the first element body portion has a same composition as powder particles in the second element body portion.

12. The inductor according to claim 1, wherein
powder particles in the first element body portion include a metal magnetic powder, and powder particles in the second element body portion include one selected from the group consisting of a ferrite powder, a nonmagnetic powder, a glass powder, and an alumina powder.

13. The inductor according to claim 1, wherein
powder particles in the first element body portion include of a ferrite powder, and powder particles in the second element body portion include one selected from the group consisting of a metal magnetic powder, a nonmagnetic powder, and a glass powder.

14. The inductor according to claim 1, wherein
a material of a through-hole has a same composition as a material of the coil, the through-hole electrically connecting the coil and the outer electrode to each other.

15. The inductor according to claim 1, wherein
a planar area of a through-hole as viewed in plan view is smaller than a planar area of the outer electrode as viewed in plan view, the through-hole electrically connecting the coil and the outer electrode to each other.

16. The inductor according to claim 1, wherein
a coefficient of linear expansion of the outer electrode is lower than a coefficient of linear expansion of the first element body portion.

17. The inductor according to claim 1, wherein
a compressive stress is generated in the second element body portion.

18. A method for manufacturing an inductor, the method comprising:
forming an element body including powder particles and a resin and incorporating a coil, wherein
the forming an element body includes
forming a precursor of a first element body portion incorporating the coil and having a first coefficient of linear expansion,
forming a precursor of a second element body portion on at least one of a first main surface or a second main surface, and having a second coefficient of linear expansion that is lower than the first coefficient of linear expansion, the first main surface facing a lower surface of the coil in the precursor of the first element body portion, and the second main surface being opposed to the first main surface,
performing heat treatment on the precursor of the first element body portion and on the precursor of the second element body portion, and
causing the precursor of the first element body portion and the precursor of the second element body portion, on which the heat treatment is performed, to be impregnated with the resin, and of performing heat treatment on the precursor of the first element body portion and the precursor of the second element body portion to obtain the element body including the first element body portion and the second element body portion, including the powder particles and the resin, and incorporating the coil, the first element body portion having the first coefficient of linear expansion, and the second element body portion having the second coefficient of linear expansion.

19. The method for manufacturing an inductor according to claim 18, wherein
in the forming a precursor of a first element body portion and the forming a precursor of a second element body portion, the precursor of the first element body portion and the precursor of the second element body portion are successively laminated.

20. The method for manufacturing an inductor according to claim 18, wherein
in the forming a precursor of a second element body portion, after the precursor of the second element body portion is formed separately from the precursor of the first element body portion, the precursor of the first element body portion and the precursor of the second element body portion, which are formed separately, are integrated with each other.
